(19) United States
(12) Patent Application Publication
(10) Pub. No.: US 2002/0077717 A1
(43) Pub. Date: Jun. 20, 2002

(54) Method and system for using electronic raw material and formula verification

(76) Inventors: Scott S. Harburda, Clinton, IN (US); Rex E. Masterson, Evansville, IN (US); Angelika H. Clark, Mt. Vernon, IN (US); Michael S. Davis, Mt. Vernon, IN (US); Dale W. Dorris, Evansville, IN (US); Jennifer L. Johnson, Jasonville, IN (US)

Correspondence Address: Deborah B. Crenshaw, Esq., Cantor Colburn LLP, 55 Griffin Road, Bloomfield, CT, 06002, US

(21) Appl. No.: 09/742,967

(22) Filed: Dec. 20, 2000

(51) Int. Cl. G06F 19/00; G06F 17/60

(52) U.S. Cl. 700/99; 705/8

(57) ABSTRACT

An exemplary embodiment is a method and system for using electronic raw material and formula verification for a product on a production line. The system includes a processor integrated with the production line for obtaining production line data, raw material data and formula data for a product produced by the production line, generating an electronic production schedule for the product, generating an electronic production run sheet including the production line data, the raw material data and the formula data for the product, receiving a product selection from the electronic production schedule, receiving a quantity selection for the product from the electronic production schedule and downloading the raw material data and the formula data to production line equipment. A network is connected to the processor, and a user system is coupled to the network for accessing the electronic production run sheet. A database is coupled to the processor for storing data relating to the production line.

### BACKGROUND

The invention relates generally to production line management, and more specifically, to a method and system for using electronic raw material and formula verification.

Many production lines, such as in the plastics industries, involve numerous processes to create an end product. In production lines where intricate or otherwise information-sensitive manufacturing is performed, correctly transferring critical production information is essential. Any number of factors may be significant to the proper running of the production line at any given time, but without the efficient, fast and accurate transfer of this information, numerous errors may occur.

For example, in the finishing of plastic pellets (which have been produced previously in a resin process), the finishing process encompasses adding various materials to the pellets. The added materials may be flame-retardants, pigment, glass, etc., depending on the final use thereof. After the addition, or what is typically called the compounding process, the pellets are extruded into an end product.

Typically, a production operator is required to manually enter the production equipment settings, such as temperatures, feeder rates, and equipment speeds. Further, information such as lot number, production identification, production settings, production readings and quality assurance (QA) data (such as physical properties and visual inspection results) are manually entered onto a production “run sheet.” Manual entry to the run sheet is required every time a new product, or production lot, is run on each production line (approximately once every eight hours for each production line). The task is manually intensive, requiring the operator to: 1) search for an appropriate unique control plan; 2) enter each setting on the equipment; and 3) write each setting on the run sheet. Therefore, valuable operator time is used, and manual entry often results in clerical data entry errors that may affect the quality and consistency of the products being produced. Moreover, the operator is often required to search for the handwritten data, which may be located in several different locations throughout the production site. In other words, the current practices are ripe for error.

Even further, the finishing of plastic pellets is typically done with very little information or knowledge about the inputs to the manufacturing process, namely the raw material's, formula's and the raw material's physical characteristics. This lack of information makes it very difficult for manufacturing engineers and quality specialists to improve the quality of the products. For example, to accurately and efficiently determine product consistency and/or the cause of a problem or failure, precise information regarding the raw materials (type, quantity, etc.) and the formula used to produce the product are needed. Typically, cumbersome manual techniques are used to verify a formula and to ensure that the raw materials are “weighed out” correctly. These techniques can cause erroneous results. Plus, the individual(s) responsible for any problems produced as a result of errors with the raw materials and/or formula(s) is not typically identified. In other words, a lack of accountability currently exists in transferring the correct raw materials to the production equipment. Also, problems may exist for both transferring the incorrect raw material(s) to the production equipment and transferring too much (or too little) raw material(s) to the production equipment. Any or all of these problems not only impact the quality of the products being made, but they may affect the performance and capacity of the production equipment.

Thus, there is a need for a more efficient, fast and accurate method and system for production line management.

### SUMMARY

An exemplary embodiment is a method and system for using electronic raw material and formula verification for a product on a production line. The system includes a processor integrated with the production line for obtaining production line data, raw material data and formula data for a product produced by the production line, generating an electronic production schedule for the product, generating an electronic production run sheet including the production line data, the raw material data and the formula data for the product, receiving a product selection from the electronic production schedule, receiving a quantity selection for the product from the electronic production schedule and downloading the raw material data and the formula data to production line equipment. A network is connected to the processor, and a user system is coupled to the network for accessing the electronic production run sheet. A database is coupled to the processor for storing data relating to the production line.

### BRIEF DESCRIPTION OF THE DRAWINGS

Referring now to the drawings wherein like elements are numbered alike in several FIGURES:

FIG. 1 depicts an exemplary electronic production run sheet in an embodiment of the invention.

FIG. 2 is a block diagram of a computer system in an embodiment of the invention.

FIG. 3 depicts an exemplary product data summary screen in an embodiment of the invention.

FIG. 4 illustrates an exemplary method for using electronic raw material and formula verification

### DETAILED DESCRIPTION

This application relates generally to commonly owned and invented U.S. application Ser. No. 09/498,035, filed Feb. 4, 2000, entitled “Method and System for Electronically Capturing, Storing, Searching and Retrieving Production Data,” the teachings of which are incorporated by reference herein.

As previously discussed, typically, the production operator is required to manually enter information to the run sheet every time a new product or production lot is run on each production line. In contrast, the invention does not require such manual entry, and therefore, the errors and problems associated with manual entry of production line data are eliminated. Therefore, productivity is increased and costs are reduced. Further, the quality and consistency of the products produced on the production line are improved by eliminating errors and problems associated with manual entry methods. Also, historical analysis of the production line data is quicker and more accurate. Furthermore, the information contained in the electronic production run sheet 80 helps to improve accountability in the raw material delivery (where a human operator is involved), insure that only the right raw materials are added to the correct production equipment, improve the analysis of the product (such as providing useful information for determining the root cause of a problem), and optimize the production process through improved “real time” knowledge of the raw materials that are actually used in the product. Furthermore, manual entry systems, such as logbooks, are not needed. Again, therefore, errors associated with manual entry are eliminated. Also, operator accountability will allow for optimizing human resources by identifying problem operators, identifying operators who could be utilized in other capacities and identifying operators who can handle additional tasks.

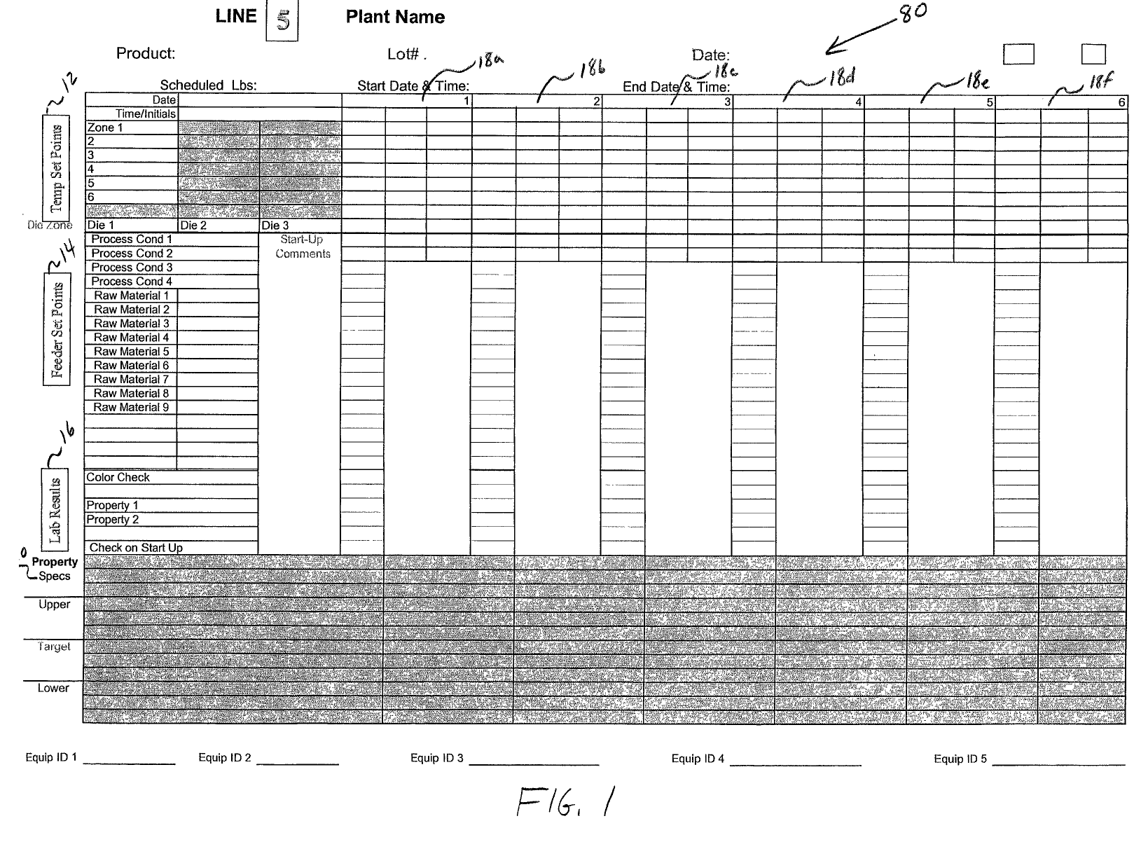

In general, an embodiment includes an electronic production run sheet 80, FIG. 1, containing production readings and quality data for a particular production line product. The manual version of a run sheet is usually in a tabular form with various columns in which the operator must record the production information by hand. After recording the product and lot number, date and time, the operator must hand write the temperature set points at 12 for the various zones of the extruder. The operator must also record various feeder set points 14. The electronic production run sheet 80 also includes lab result data points 16. The properties of the product during the various runs 18a-18f are determined and plotted in a Statistical Quality Control Graph (SQC) 20.

Although the system of an embodiment is described with relation to plastics finishing, it should be appreciated that the system and method described herein can be applied to various other manufacturing and data retrieval and storage environments.

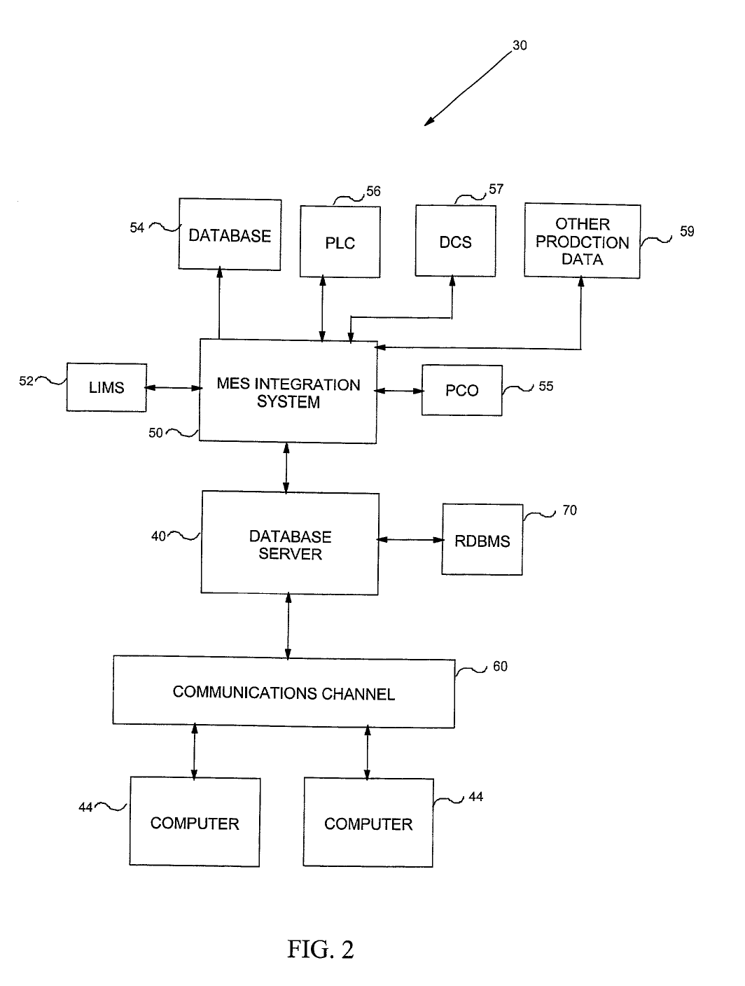

An embodiment utilizes a manufacturing execution system (MES) computer system 30. Referring to FIG. 2, the computer architecture of the MES computer system 30 will be described. The MES computer system 30 includes a database server 40 and computers 44. Although only two computers 44 are shown for simplicity it should be appreciated that a plurality of computers can be located at different locations in the production site for use by a plurality of operators. Moreover the database server 40 can be identical to computer 44 and is distinguishable as an embodiment only in that server 40 is the primary data storage source with which data stored in computers 44 can be synchronized therewith.

Computer(s) 44 are coupled to the database server 40 by communications channel 60. Communications channel 60 can be a network, such as a wide area network (WAN), local area network (LAN), Ethernet, intranet, a direct cable connection, a connection via phone lines and modems, or the like. Further, communications channel 60 can be continuous or intermittent and can be any mechanism for providing the communications described below. For example, communications channel 60 can include removable media, such as a diskette. Data can be sent over communications channel 60 in any appropriate format, such as e-mail in simple mail transfer protocol (SMTP), as attachments to email, as ASCII or binary files using file transfer protocol (FTP), or the like.

Even further, communications channel 60 can be the Internet. In such an embodiment, computer(s) 44 execute a user application (e.g., web browser) for interacting with the database server 40. Communication with computer(s) 44 can be achieved in any manner consistent with Internet information transfer, including but not limited to, HTTP and FTP, or a client/server connection.

Likewise, system components may be located remotely from each other and coupled via communications channel 60. For example, the database server 40 may be located off-site of the production line and communicates with corresponding components via communications channel 60 as a network, such as the Internet, WAN, LAN, Ethernet, intranet, a direct cable connection, a connection via phone lines and modems, or the like. Such remote locating is useful if, for example, the production facility environment is too extreme for the components.

The database server 40 is managed by a relational database management system (RDBMS) 70, such as the ORACLE RELATIONAL DATABASE MANAGEMENT SYSTEM by Oracle Corporation of Redwood Shores, Calif. RDBMS 70 manages a relational database to store the data. The data records, data tables, and data relationships contained in the database managed by RDBMS 70 enable the MES computer system 30 to provide increased reliability in searching and analyzing quality assurance (QA) lab testing data.

In the MES computer system 30, the database server 40 is a computer having sufficient resources to support RDBMS 70. Moreover, the database server 40 supports multi-operator access to RDBMS 70 over a computer network. Each operator computer terminal 44 should be sufficient to support an operating system such as WINDOWS 98, UNIX or other similar operating systems. These systems are used for communication with the Laboratory Information Management System (LIMS) 52, which executes on computers 44, as well.

As discussed, computers 44 execute application programs, which communicate with RDBMS 70 to query the databases managed by RDBMS 70 and to provide data for that database. The LIMS database 52 in this process involves the display and storage of the lab tests, along with the required specifications, and is another source of production data, such as the test results of the product properties.

The QA lab test data are available electronically throughout the LIMS database 52 described above (an electronic database system on the network). The production readings are the readings from the production line captured real time through the MES computer system 30. Using the configuration of the MES computer system 30, this data can be captured at a specified interval (such as, every second, every ten minutes, or whatever is required) or when there is a change in the data greater than a predetermined threshold (such as, a change of 2 degrees in temperature, or a change in 1 pound per hour feed rate). Once again, this data is stored in the database system and is available electronically through the communications channel 60.

During a production line check, which occurs when a QA lab test occurs, the operator enters appropriate information into the computerized system. This causes a “snap shot” of the production process to be captured. The production readings are the sensor readings for production: temperatures, pressure, motor speeds, motor amps, humidity, feeder rates, feeder selection, production rates, etc. The QA lab test data are the results of the required product tests: rheology measurement, appearance, compositional analysis, strength tests, color, etc. This information is captured with the additional capability to record operator comments. The QA lab test data is stored electronically in LIMS 52 and can be updated at any time. Thus, the operators can add comments following the QA lab test entry whenever they want or are required to (for example, 10 minutes later or even 10 days later). The date/time stamp of the production data report will include all updates to the database system up to that date/time.

The data captured by the LIMS is displayed using SQC graphs to indicate quality of the product and/or process. The data can be captured each time a QA lab test occurs (or at other convenient times), also known as a production line check.

The MES computer system 30 includes a variety of features. Data exchange between the database server 40 and the different databases, such as LIMS 52, can occur due to the use of the MES integration system 50. This acts as an interface between the database server 40 and LIMS 52, database 54, process control operations (PCO) system 55 for controlling the production equipment operations, programmable logic controller (PLC) interface 56 with production real-time data or distributed control system (DCS) 57 and other additional production data, such as scheduling via another production data database 59. Data exchange also occurs due to the use of a compliant language such as VISUAL BASIC (VB) from Microsoft Corporation of Redmond, Wash. For example, the line schedule can be determined via VB application programming interface (API) to the RDBMS 70 and other databases. If necessary, functionality modules can be used to group the production data by batches or lots. The line schedule also can be determined via various methods, such as manually, via database 54 or via an electronic schedule program interfaced with the RDBMS 70.

A PLC interface 56, for example GE 90-70, allows for the snap shot of the process to be retrieved at a particular sample time. The PLC interface 56 allows production parameters to be set and controlled. As such, this system has the electronic capability to capture the production parameters and send them to a database system with the appropriate date/time stamps.

The VB API program also allows the operator to retrieve the production run data in the snap shot format by entering the line number, product number or date in the appropriate windows of the electronic production run sheet 80 screen. The line number and product number are pull-down menus that the operators can select. The date is a manual entry block. Each of these allows the operator to search the database system for historical batches (or lots). Because there are several thousand lots made each year, this makes it easier for data retrieval.

The data from a particular line check can be maintained for at least three years due to VB API access and a 40-gigabyte RAID-5-disk array. The particular storage amount is dependent upon the storage capacity, whereas the required length of storage is dependent upon policy dictating document retention.

Feeder rate settings of the extruder can be displayed from database 54 due to VB API and the database 54 RDBMS interface. Generic production settings (such as feeders, temperatures, etc.) can be downloaded from other system databases, such as database 54. This could be sent to the PLC interface 56 or to the electronic production run sheet 80 via the MES interfaces.

RDBMS 70 also allows for the operator to manually enter operator comments for each line check. This is also accomplishable by the VB API access to RDBMS 70 and other databases. The VB API is a visual basic program, which allows for an additional field in the database system, which can store the operator comments. There is a control function, or button on the electronic production run sheet 80 which will allow the operator to enter and to display comments for each line check of for the entire production run. The VB API program will prompt the operator to enter his/her data and will then send it to the appropriate database system.

The VB API program also allows the operator to print a hard copy of the electronic production run sheet 80 and to print a pre-configured report for the production run. This will retrieve the appropriate batch (or lot) production and QA lab test data for printout on the pre-configured report format, similar to the one displayed in FIG. 1.

As discussed above, a statistical quality control (SQC) graph can chart the melt flow index, melt viscosity or any other property of interest due to RDBMS 70, and other databases. The data for the SQC charts would come from the various databases, depending upon which property was chosen for graphing. The actual charting of the SQC graph will either be done using existing statistical graphing packages or through programming using generic (well-known) equations.

The system can include production alarms to indicate that a feeder has stopped or a product property is no longer within specification. These alarms are available in the electronic production run sheet 80 which allow operators the required information in real-time to make corrections. The database system contains the appropriate tolerances for the parameters and other software, such as TELALERT. It also contains the appropriate alarming system for activating alarms such as lights, horns, etc. The electronic production run sheet 80 contains a graphical alarm and a text display indicating what the alarm is for.

The database server 40 acts as a universal user interface due to RDMS 70, GE 90-70 PLC interface 56, EDCP RDBMS, VB API access. Furthermore, utilizing standard technology and tool sets such as VB, structured query languages (SQL), object linking and embedding (OLE) for process control, open database connectors (ODBC) and ActiveX controls also allow for universal user interface.

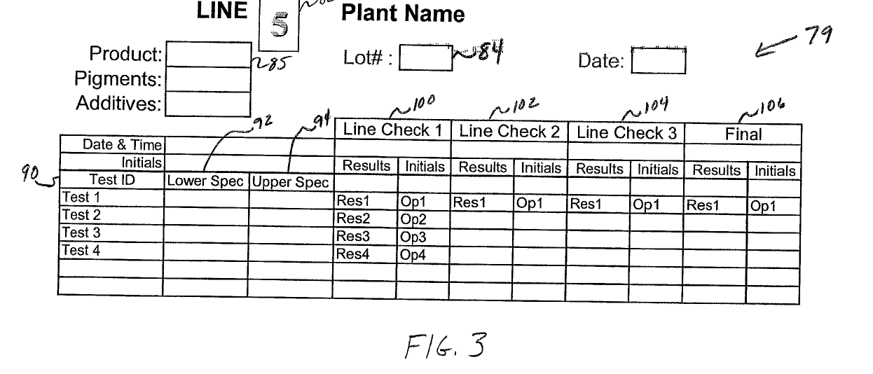

Referring to FIG. 3, the LIMS will be described in relation to the screen capture shown. The product data summary screen 79 shown in FIG. 3 involves an automatic system for capturing the lot number, product identifiers, machine set points, production readings and the QA lab test data. The production readings and the QA lab test data are available electronically through the MES and LIMS computer systems. During a production line check an operator can enter information such as the line number in window 82 or the lot number in window 84 and pull up the data on the particular production line by pressing a fetch lot button (not shown).

Lot information such as the grade and color may also appear in windows on the product data summary screen 79 (not shown). Product window 85 may include a product code to identify special product requirements for a customer. Test Id column 90 may include a plurality of different tests identified by, for example, Test1-Test4. Each product made in the plastics finishing process has different tests and test codes, and the system has a test ID relating to a particular test preformed. For example, a specific gravity test could have a test ID of SP GRAV, which would appear in column 90.

For each data reading, a lower spec and an upper spec are displayed in tabular form at 92 and 94. In order to determine which individual performed which test, the testers initials can be added in another column (shown as “Op1-Op4 in FIG. 3). The line check data is shown in columns 100 through 106, etc., with the final run 106 appearing to the right. It should be appreciated that there is no time limit or a limit to the amount of line checks that can be performed.

A window for operator comments may be included at the bottom of the screen (not shown). When complete the operator can print a final report. The SQC graph can also be displayed on the electronic production run sheet 80. The format or display of the data in the SQC graph is determined by the configuration parameters, such as the frequency of reports, whether actual data points or average data points are used, etc.

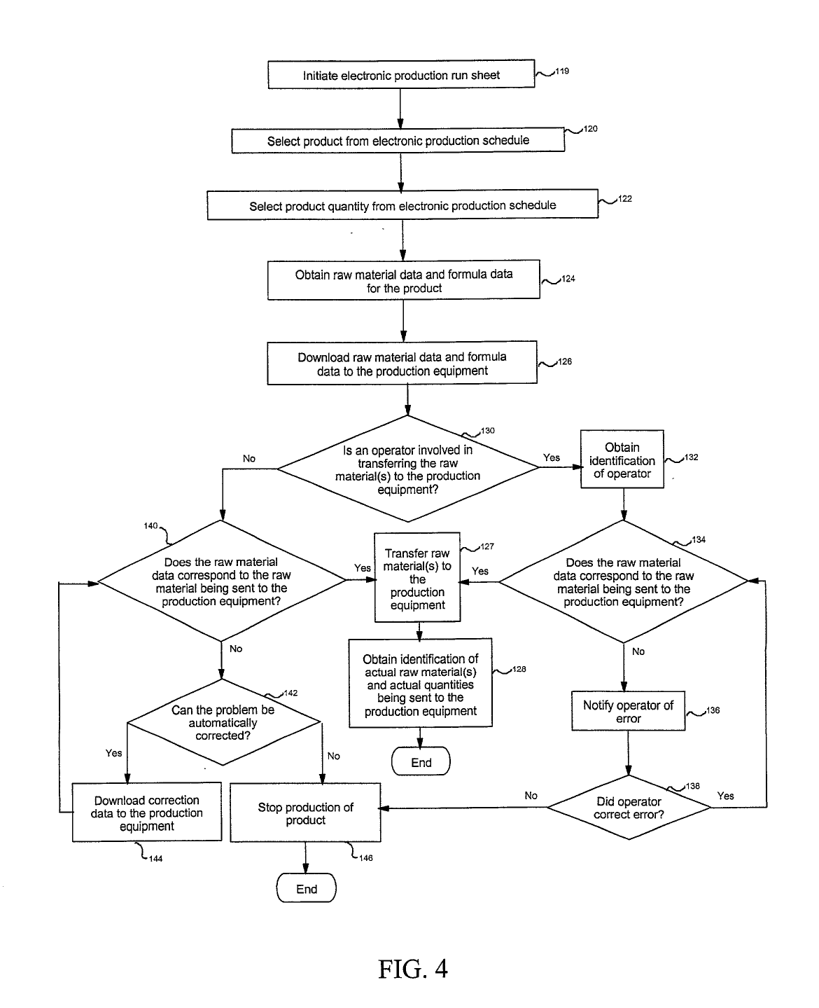

FIG. 4 is a flow chart of an exemplary method for using electronic raw material and formula verification. The method of FIG. 4 may be implemented by an operator using one of the computer(s) 44 or even automatically based on production schedule information previously entered to the MES computer system 30. First, in step 119, the electronic production run sheet 80 is initiated. The electronic production run sheet 80 may be initiated automatically or by operator selection. Next, in step 120, a specific product is selected for production from an electronic production schedule. The electronic production schedule may be integral to or accessed via the electronic production run sheet 80. Product selection can be determined any number of ways, such as by selecting a product according to its unique production lot number or serial number. The production lot number can correspond to a particular product grade, color, customer and production line.

In step 122, the quantity of the product to be produced is selected from the electronic production schedule. Next, in step 124, the raw material data and formula data corresponding to the product selection and quantity selection is obtained. As discussed, an embodiment utilizing the MES computer system 30 may include the RDBMS for managing the relational database to store the data. A product's formula data and raw material data may be stored in such a database. For example, in the finishing of plastic pellets, raw material data may include raw material type, raw material lot number, physical properties of the raw material (such as molecular weight and viscosity), raw material vendor and previous location of the raw material. Formula data may include the type and identity of one or more raw materials, along with the quantity to be sent to the production equipment. The production equipment may include one or more raw material feeding systems (such as blend hoppers).

In step 126, the raw material data and formula data is downloaded to the production equipment. The MES interfaces have the capability to download data to the production equipment via the PCO system 55.

In step 130, whether an operator is involved in transferring the raw material(s) to the production equipment is determined. If an operator is involved, then in step 132, the operator's identification is obtained. Operator identities may also be stored in the relational database to allow for accountability and human resource analysis. Note that the operator's identity may be obtained at an earlier step, such as prior to transferring the actual raw material(s) and actual quantities to the production equipment. Again, the operator's identity may be obtained several ways, such as via keyed entry, voice input, bar-code type scanning of the operator's identification badge, and the identity may even be automatically entered based on production information previously entered to the MES computer system 30.

Next, in step 134, whether the raw material data corresponds to the raw material being sent to the production equipment is determined. If the raw material data corresponds to the raw material being sent to the production equipment, then in step 127, the actual raw material(s) is transferred to the production equipment. In step 128, the actual raw material(s) information and actual quantity sent to the production equipment is obtained by downloading the information to the electronic production run sheet 80. The information regarding the actual raw material(s) and associated quantities may be obtained several ways. For example, the information may be entered via keyed entry, voice input, bar-code type scanning of identification labels, and the information may even be automatically entered based on production information previously entered to the MES computer system 30. The raw material(s) information may also be archived in a searchable database for later retrieval. Such retrieval is advantageous in the manufacture of products covered by government laws and regulations, such as pharmaceutical and food/beverage products. If the raw material data does not correspond to the raw material being sent to the production equipment, the operator is notified of the error in step 136. Next, in step 138, whether the operator corrected the error is determined. If the operator corrected the error, step 134 is repeated. However, repeating step 134 may be omitted in cases where the operator's correction does not need to be confirmed. If the operator did not correct the error, production may be halted in step 146. Production may be halted any number of ways, including notifying the operator to halt production via an alarm system and/or automatically halting production via an interlocking mechanism. The interlock may be in any form (such as mechanical, electrical and/or computer program) that will prevent the production equipment from operating, if needed. If, in step 130, no operator is involved in transferring the raw material(s) to the production equipment, then in step 140, whether the raw material data corresponds to the raw material being sent production equipment is determined. Again, if the raw material data corresponds to the raw material being sent to the production equipment, steps 127 and 128 are performed. Otherwise, in step 142, whether the problem can be automatically corrected is determined. If not, in step 146, production may be halted and the process may end. If, in step 142, the problem can be automatically corrected, in step 144, correction data is downloaded to the production equipment. To verify that the correction data resolved the problem, step 140 is repeated. Again, this verification step may be omitted.

The description applying the above embodiments is merely illustrative. As described above, embodiments in the form of computer-implemented processes and apparatuses for practicing those processes may be included. Also included may be embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Also included may be embodiments in the form of computer program code, for example, whether stored in a storage medium, loaded into and/or executed by a computer, or as a data signal transmitted, whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

What is claimed is:

1. A system for using electronic raw material and formula verification for a product on a production line, the system comprising:
a processor integrated with said production line for obtaining production line data, raw material data and formula data for a product produced by said production line, generating an electronic production schedule for said product, generating an electronic production run sheet including said production line data, said raw material data and said formula data for said product, receiving a product selection from said electronic production schedule, receiving a quantity selection for said product from said electronic production schedule and downloading said raw material data and said formula data to production line equipment;
a network connected to said processor;
a user system coupled to said network, said user system accessing said electronic production run sheet; and
a database coupled to said processor for storing data relating to said production line.

2. The system of claim 1, further including:
said processor comparing said raw material data with raw material being used to produce said product;
said processor determining whether said raw material data corresponds to said raw material; and
said processor downloading correction data to said production line equipment if said raw material data does not correspond to said raw material.

3. The system of claim 1, further including:
said processor comparing said formula data with a formula being used to produce said product;
said processor determining whether said formula data corresponds to said formula; and
said processor downloading correction data to said production line equipment if said formula data does not correspond to said formula.

4. The system of claim 1, further including said processor obtaining physical characteristics of raw material being used to produce said product.

5. The system of claim 4, wherein said generating further includes said electronic production run sheet including said physical characteristics.

6. The system of claim 1, further including said processor obtaining information for a formula being used to produce said product.

7. The system of claim 6, wherein said generating further includes said electronic production run sheet including said information.

8. The system of claim 1, further including said processor obtaining quality data for said product.

9. The system of claim 8, wherein said generating further includes said electronic production run sheet including said quality data for said product.

10. The system of claim 8, wherein said obtaining quality data is performed at a predetermined interval.

11. The system of claim 8, wherein said obtaining quality data occurs automatically in response to a change in said quality data which is greater than a predetermined threshold.

12. The system of claim 1, wherein said downloading said raw material data and said formula data occurs automatically upon receiving a selection from said electronic production schedule.

13. The system of claim 1, further including said processor downloading said production line equipment settings to said electronic production run sheet.

14. The system of claim 1, wherein said obtaining production line data is performed at a predetermined interval.

15. The system of claim 1, wherein said obtaining production line data occurs automatically in response to a change in said production line data which is greater than a predetermined threshold.

16. The system of claim 1, wherein said generating further includes supplemental user comments.

17. The system of claim 1, wherein said production line equipment includes at least one raw material feeding system.

18. The system of claim 1, further including said processor obtaining the identity of a production operator responsible for producing said product.

19. The system of claim 18, wherein said generating further includes said electronic production run sheet including said identity.

20. A method for using electronic raw material and formula verification for a product on a production line, the method comprising:
obtaining production line data, raw material data and formula data for a product produced by said production line;
generating an electronic production schedule for said product;
generating an electronic production run sheet including said production line data, said raw material data and said formula data for said product;
receiving a product selection from said electronic production schedule;
receiving a quantity selection for said product from said electronic production schedule; and
downloading said raw material data and said formula data to production line equipment.

21. The method of claim 20, further including:
comparing said raw material data with raw material being used to produce said product;
determining whether said raw material data corresponds to said raw material; and
downloading correction data to said production line equipment if said raw material data does not correspond to said raw material.

22. The method of claim 20, further including:
comparing said formula data with a formula being used to produce said product;
determining whether said formula data corresponds to said formula; and downloading correction data to said production line equipment if said formula data does not correspond to said formula.

23. The method of claim 20, further including obtaining physical characteristics of raw material being used to produce said product.

24. The method of claim 23, wherein said generating further includes said electronic production run sheet including said physical characteristics.

25. The method of claim 20, further including obtaining information for a formula being used to produce said product.

26. The method of claim 25, wherein said generating further includes said electronic production run sheet including said information.

27. The method of claim 20, further including obtaining quality data for said product.

28. The method of claim 27, wherein said generating further includes said electronic production run sheet including said quality data for said product.

29. The method of claim 27, wherein said obtaining quality data is performed at a predetermined interval.

30. The method of claim 27, wherein said obtaining quality data occurs automatically in response to a change in said quality data which is greater than a predetermined threshold.

31. The method of claim 20, wherein said downloading said raw material data and said formula data occurs automatically upon receiving a product selection from said electronic production schedule.

32. The method of claim 20, further including downloading said production line equipment settings to said electronic production run sheet.

33. The method of claim 20, wherein said obtaining production line data is performed at a predetermined interval.

34. The method of claim 20, wherein said obtaining production line data occurs automatically in response to a change in said production line data which is greater than a predetermined threshold.

35. The method of claim 20, wherein said generating further includes supplemental user comments.

36. The method of claim 20, wherein said production line equipment includes at least one raw material feeding system.

37. The method of claim 20, further including obtaining the identity of a production operator responsible for producing said product.

38. The method of claim 37, wherein said generating further includes said electronic production run sheet including said identity.

39. A storage medium encoded with machine-readable computer program code for using electronic raw material and formula verification for a product on a production line, said storage medium including instructions for causing a processor to implement a method comprising:
obtaining production line data, raw material data and formula data for a product produced by said production line;
generating an electronic production schedule for said product;
generating an electronic production run sheet including said production line data, said raw material data and said formula data for said product;
receiving a product selection from said electronic production schedule;
receiving a quantity selection for said product from said electronic production schedule; and
downloading said raw material data and said formula data to production line equipment.

40. The storage medium of claim 39, further including instructions for causing said processor to implement:
comparing said raw material data with raw material being used to produce said product;
determining whether said raw material data corresponds to said raw material; and
downloading correction data to said production line equipment if said raw material data does not correspond to said raw material.

41. The storage medium of claim 39, further including instructions for causing said processor to implement:
comparing said formula data with a formula being used to produce said product;
determining whether said formula data corresponds to said formula; and
downloading correction data to said production line equipment if said formula data does not correspond to said formula.

42. The storage medium of claim 39, further including instructions for causing said processor to implement obtaining physical characteristics of raw material being used to produce said product.

43. The storage medium of claim 42, wherein said generating further includes said electronic production run sheet including said physical characteristics.

44. The storage medium of claim 39, further including instructions for causing said processor to implement obtaining information for a formula being used to produce said product.

45. The storage medium of claim 44, wherein said generating further includes said electronic production run sheet including said information.

46. The storage medium of claim 39, further including instructions for causing said processor to implement obtaining quality data for said product.

47. The storage medium of claim 46, wherein said generating further includes said electronic production run sheet including said quality data for said product.

48. The storage medium of claim 46, wherein said obtaining quality data is performed at a predetermined interval.

49. The storage medium of claim 46, wherein said obtaining quality data occurs automatically in response to a change in said quality data which is greater than a predetermined threshold.

50. The storage medium of claim 39, wherein said downloading said raw material data and said formula data occurs automatically upon receiving a selection from said electronic production run sheet.

51. The storage medium of claim 39, further including instructions for causing said processor to implement downloading said production line equipment settings to said electronic production run sheet.

52. The storage medium of claim 39, wherein said obtaining production line data is performed at a predetermined interval.

53. The storage medium of claim 39, wherein said obtaining production line data occurs automatically in response to a change in said production line data which is greater than a predetermined threshold.

54. The storage medium of claim 39, wherein said generating further includes instructions for causing said processor to implement including supplemental user comments.

55. The storage medium of claim 39, wherein said production line equipment includes at least one raw material feeding system.

56. The storage medium of claim 39, further including instructions for causing said processor to implement obtaining the identity of a production operator responsible for producing said product.

57. The storage medium of claim 56, wherein said generating further includes said electronic production run sheet including said identity.

58. A computer data signal for using electronic raw material and formula verification for a product on a production line, said computer data signal comprising code configured to cause a processor to implement a method comprising:
obtaining production line data, raw material data and formula data for a product produced by said production line;
generating an electronic production schedule for said product;
generating an electronic production run sheet including said production line data, said raw material data and said formula data for said product;
receiving a product selection from said electronic production schedule;
receiving a quantity selection for said product from said electronic production schedule; and
downloading said raw material data and said formula data to production line equipment.

59. The computer data signal of claim 58, wherein said computer data signal is embodied in a carrier wave.

60. The computer data signal of claim 58, wherein said computer data signal is unmodulated.

61. The computer data signal of claim 58, further including code configured to cause said processor to implement:
comparing said raw material data with raw material being used to produce said product;
determining whether said raw material data corresponds to said raw material; and
downloading correction data to said production line equipment if said raw material data does not correspond to said raw material.

62. The computer data signal of claim 58, further including code configured to cause said processor to implement:
comparing said formula data with a formula being used to produce said product;
determining whether said formula data corresponds to said formula; and
downloading correction data to said production line equipment if said formula data does not correspond to said formula.

63. The computer data signal of claim 58, further including code configured to cause said processor to implement obtaining physical characteristics of raw material being used to produce said product.

64. The computer data signal of claim 63, wherein said generating further includes said electronic production run sheet including said physical characteristics.

65. The computer data signal of claim 58, further including code configured to cause said processor to implement obtaining information for a formula being used to produce said product.

66. The computer data signal of claim 65, wherein said generating further includes said electronic production run sheet including said information.

67. The computer data signal of claim 58, further including code configured to cause said processor to implement obtaining quality data for said product.

68. The computer data signal of claim 67, wherein said generating further includes said electronic production run sheet including said quality data for said product.

69. The computer data signal of claim 67, wherein said obtaining quality data is performed at a predetermined interval.

70. The computer data signal of claim 67, wherein said obtaining quality data occurs automatically in response to a change in said quality data which is greater than a predetermined threshold.

71. The computer data signal of claim 58, wherein said downloading said raw material data and said formula data occurs automatically upon receiving a selection from said electronic production run sheet.

72. The computer data signal of claim 58, further including code configured to cause said processor to implement downloading said production line equipment settings to said electronic production run sheet.

73. The computer data signal of claim 58, wherein said obtaining production line data is performed at a predetermined interval.

74. The computer data signal of claim 58, wherein said obtaining production line data occurs automatically in response to a change in said production line data which is greater than a predetermined threshold.

75. The computer data signal of claim 58, wherein said generating further includes code configured to cause said processor to implement including supplemental user comments.

76. The computer data signal of claim 58, wherein said production line equipment includes at least one raw material feeding system.

77. The computer data signal of claim 58, further including code configured to cause said processor to implement obtaining the identity of a production operator responsible for producing said product.

78. The computer data signal of claim 77, wherein said generating further includes said electronic production run sheet including said identity.
